(19) United States
(12) Patent Application Publication
(10) Pub. No.: US 2007/0056141 A1
(43) Pub. Date: Mar. 15, 2007

(54) Powered locking caster wheel

(76) Inventors: Sergio Armano, St. Chrysostome (CA); Brian D. Hass, Torrington, CT (US)

Correspondence Address: SCHWEITZER CORNMAN GROSS & BONDELL LLP, 292 MADISON AVENUE - 19th FLOOR, NEW YORK, NY, 10017, US

(21) Appl. No.: 11/519,536

(22) Filed: Sep. 12, 2006

Related U.S. Application Data
(60) Provisional application No. 60/716,940, filed on Sep. 15, 2005.

(51) Int. Cl. B60B 33/00

(52) U.S. Cl. 16/35 R

(57) ABSTRACT

A caster wheel, comprising a wheel contained between covers; a drive assembly connected to the covers; and a locking assembly connected to the drive assembly, the locking assembly applying pressure to a surface of the wheel under action of the drive assembly, thereby controlling a rotation of the wheel around both a vertical and horizontal axis.

### CROSS REFERENCE TO RELATED APPLICATIONS

This application claims priority on U.S. provisional application No. 60/716,940, filed on Sep. 15, 2005. All documents above are herein incorporated by reference

### FIELD OF THE INVENTION

The present invention relates to locking caster wheels. More specifically, the present invention is concerned with powered locking caster wheels.

### BACKGROUND OF THE INVENTION

Caster wheels currently on the market require a user to apply physical power to the wheel by pressing some sort of actuation lever. This lever may be directly attached to the wheel or may be attached by means of a linkage, thereby allowing the user's action to lock or unlock the wheel.

There are three basic functional types of caster wheels. Free wheeling caster wheels have no locking mechanism. Partial locking wheels can lock the vertical axis in a particular direction, whereby the wheel is only allowed to roll parallel to a supported load, while allowing the wheel to rotate around the horizontal axis, or they can lock both the vertical and horizontal rotation, whereby the wheel is prevented from rolling. Total locking caster wheels lock rotation about both the horizontal axis and the vertical axis.

FIG. 1 shows a typical caster wheel application which uses a series of linkages 8, 10, 11, 12 to allow a user to actuate all four caster wheels 6 by pressing a lever or foot pedal 9. Pressing the pedal 9 in one direction will lock the vertical direction of one or more wheels so the caster wheel will rotate parallel to the direction of movement in order to facilitate steering of the load. Pressing the pedal 9 in the opposite direction will cause one or more wheels to lock in both the vertical and horizontal axis to prevent any movement of the load.

FIGS. 2 to 4 show various locking states of a caster wheel: in a neutral state, rotation is allowed in both the vertical and horizontal axis; in a total lock state, rotation in both the vertical and horizontal axis is prevented; in a rotational or partial lock state, rotation around the vertical axis is prevented and the wheels are locked so that the wheel rotation is parallel to the direction of the load.

### SUMMARY OF THE INVENTION

There is provided a caster wheel, comprising a wheel contained between covers; a drive assembly connected to the covers; and a locking assembly connected to the drive assembly, the locking assembly applying pressure to a surface of the wheel under action of the drive assembly, thereby controlling a rotation of the wheel around both a vertical and horizontal axis.

There is further provided an assembly comprising a number of caster wheels, each caster wheel comprising a wheel contained between covers; a drive assembly connected to the covers; and a locking assembly connected to the drive assembly, the locking assembly applying pressure to a surface of the wheel under action of the drive assembly, thereby controlling a rotation of the wheel around both a vertical and horizontal axis, each caster wheel being provided with a locking mechanism.

There is further provided an assembly, comprising a number of caster wheels, each caster wheel comprising a wheel contained between covers; a drive assembly connected to the covers; and a locking assembly connected to the drive assembly, the locking assembly applying pressure to a surface of the wheel under action of the drive assembly, thereby controlling a rotation of the wheel around both a vertical and horizontal axis, the caster wheels being connected by a linkage driven by a central assembly drive.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 shows a manually actuated caster wheel according to the prior art;

FIGS. 2 to 4 show three locking conditions of a caster wheel;

FIG. 5 is an exploded view of a power locking caster wheel according to a first embodiment of the present invention;

FIG. 6 is an exploded perspective view of a drive assembly of the powered caster wheel of FIG. 5;

FIG. 7 is an exploded perspective view of an internal shaft assembly of the drive assembly of FIG. 6;

FIG. 8 is an exploded perspective view of a motor assembly in the drive assembly of FIG. 6;

FIG. 9 is and exploded perspective view of the locking assembly of the powered caster wheel of FIG. 5;

FIG. 10 is a cross section view of the power locking caster wheel of FIG. 5;

FIGS. 11 to 14 show the powered locking caster wheel of FIG. 5 in various locking conditions;

FIG. 15 is an exploded perspective view of a power locking caster wheel according to a second embodiment of the present invention;

FIG. 16 is an exploded perspective view of the drive assembly of the power locking caster wheel of FIG. 15;

FIG. 17 is an exploded perspective view of the internal shaft assembly of the drive assembly of FIG. 16;

FIG. 18 is an exploded perspective view of the locking assembly of the power locking caster wheel of FIG. 15;

FIGS. 19 to 23 show the powered locking caster wheel of FIG. 15 in various locking conditions;

FIG. 24 is an exploded perspective view of a powered locking caster wheel according to a third embodiment of the present invention;

FIG. 25 is an exploded perspective view of a lever assembly of the powered caster wheel of FIG. 24;

FIG. 26 shows the powered caster wheel of FIG. 24 in a total lock condition; and

FIG. 27 shows a power locking caster wheel according to a further embodiment of the present invention, which allows locking several wheels through an existing or new central linkage system by means of a powered actuator.

### DESCRIPTION OF ILLUSTRATIVE EMBODIMENTS

The present invention is illustrated in further details by the following non-limiting examples.

In a first embodiment illustrated in FIG. 5 of the appended drawings, a powered caster wheel comprises a wheel 1 between two covers 2 and 3, a locking assembly 4, and a drive assembly 5.

The locking assembly 4 is used to control a rotation of the wheel 1 around both a vertical and horizontal axis; it may move up and down to apply pressure to the surface of the wheel 1, under a force applied through the drive assembly 5.

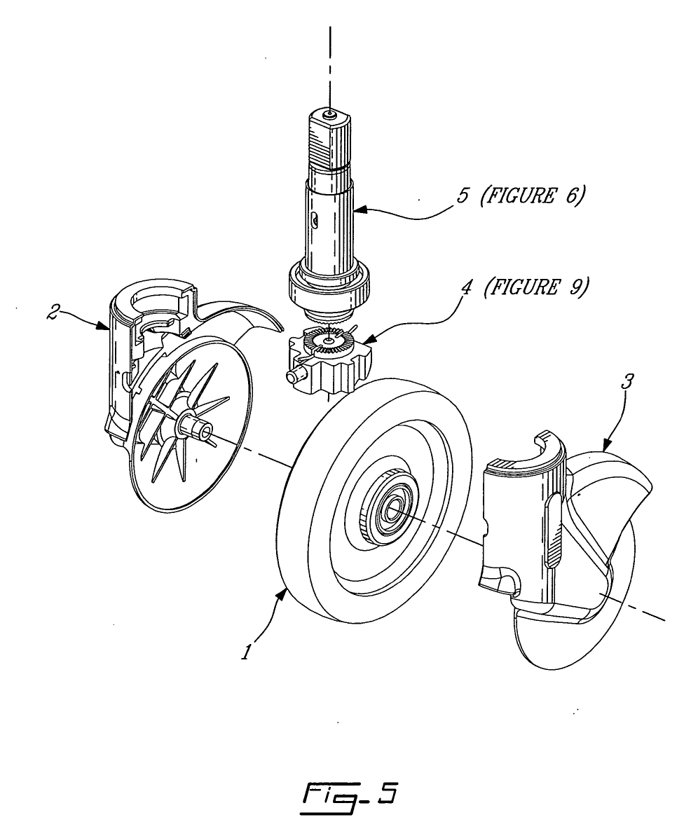

As best seen in FIG. 6, the drive assembly 5 comprises an internal shaft assembly 14, which has an upper and lower portion which rotate independently. The internal shaft assembly 14 slides up and down in an external shaft 16 having a mating shape to prevent rotation between the lower portion of the internal shaft assembly 14 and external shaft 16. The internal shaft assembly 14 is driven up and down by a motor assembly 13. The upper portion of the internal shaft assembly 14 is prevented from rotating by fasteners 21. The internal shaft assembly 14 is connected to a brake foot 19 through a mating shape and a retainer 20. A resilient elastic spring 18 is placed between the brake foot 19 and the external shaft 16 to allow a smooth stop in the upward direction. The internal shaft assembly 14 is forced upwardly by a spring 15. The drive assembly 5 is mounted on the covers 2 and 3 of the caster wheel by means of a bearing 17.

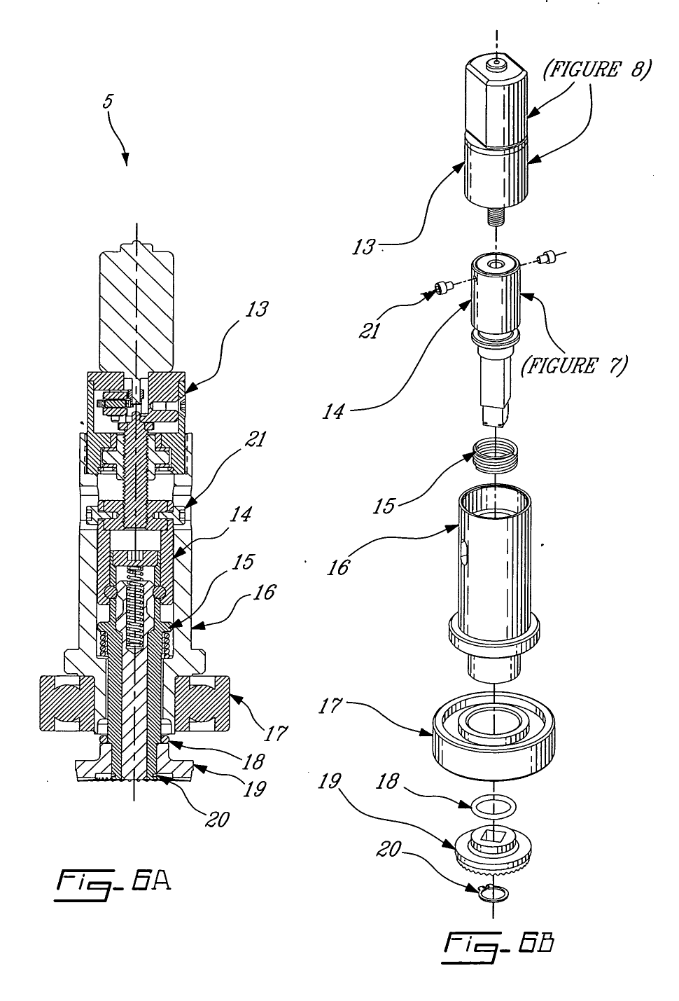

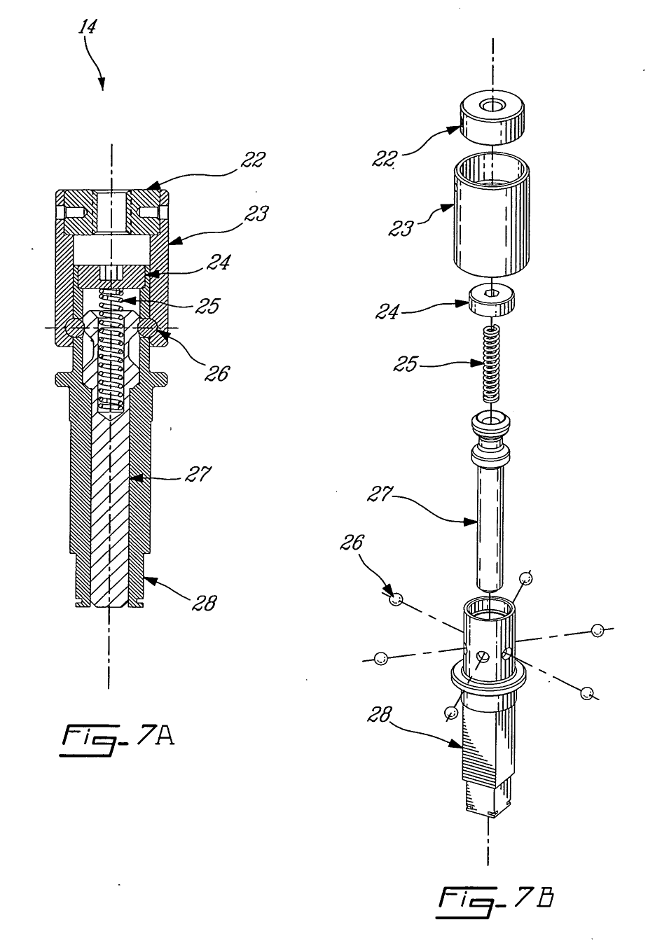

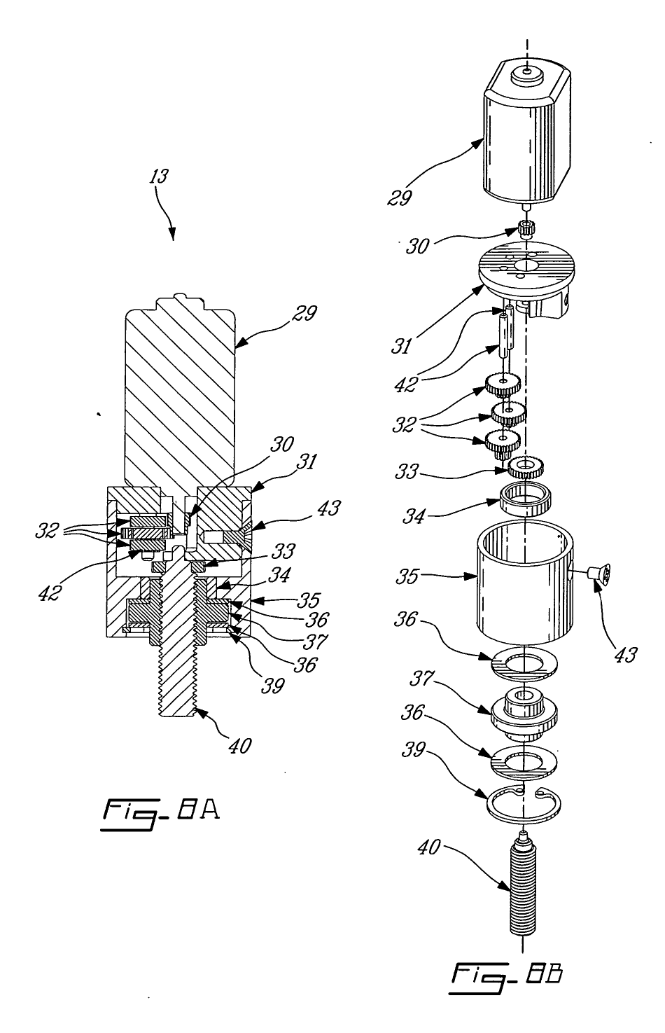

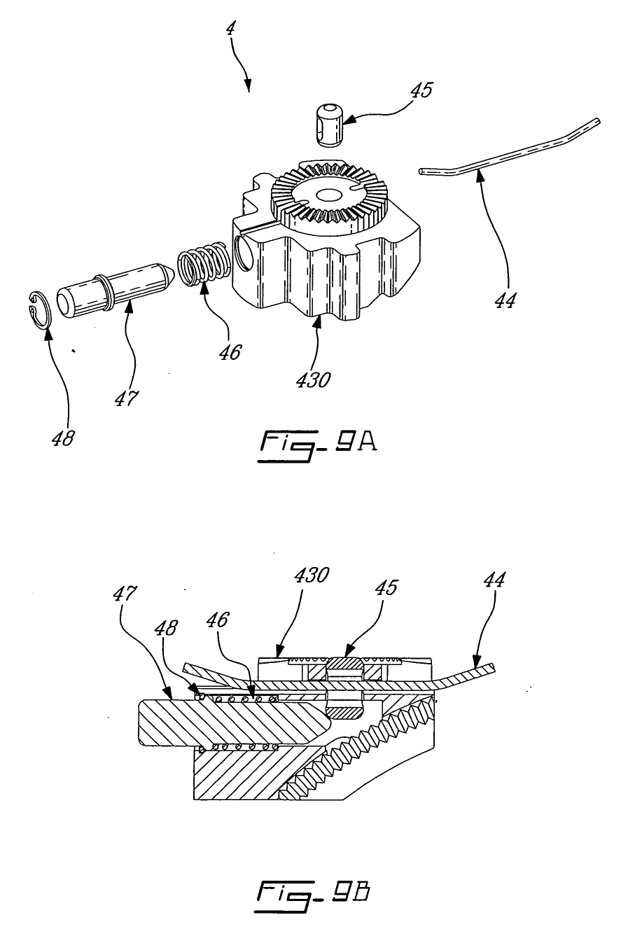

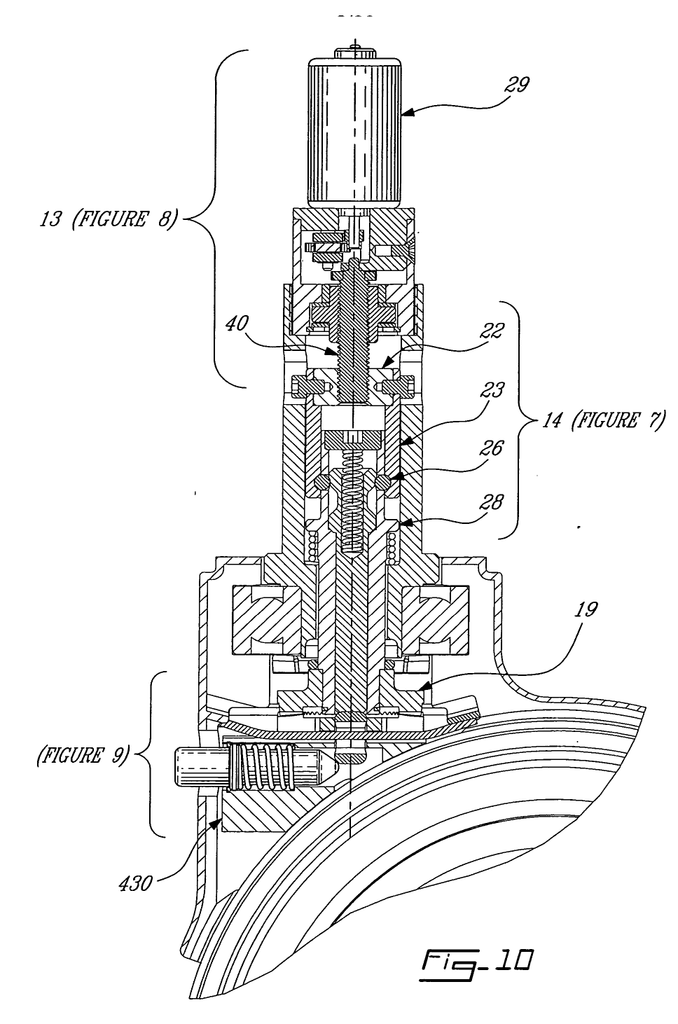

The internal shaft assembly 14 shown in FIG. 7 comprises a threaded drive nut 22 made of a low friction material such as ail sintered bronze or plastic connected to a housing 23. The housing 23 is connected to a square shaft 28 through six balls 26. The housing 23 has a circular undercut while the square shaft 28 has six mating holes, which allow the balls 26 to transmit linear force between the housing 23 and the square shaft 28. The six balls 26 are held in place by a release shaft 27, which is loaded by a spring 25, which is contained by a cap 24.

The motor assembly 13 shown in FIG. 8 comprises an electric motor 29, which has an output pinion gear 30 matting with several gears 32 to reduce the motor speed and increase torque. The motor 29 may also be powered by pneumatic or hydraulic means. The gears 32 are held in place by pins 41 which are assembled in a motor adapter 31. A drive screw 40 is driven by an output gear 33 which mates with the drive gear 32 and held in place by a bushing 34. The thrust of the drive screw 40 is supported by a bearing 37 and two thrust washers 36 which are held in place by the drive housing 35 and a retaining ring 39. The motor adapter 31 is assembled to the drive housing 35 using a fastener 43.

The motor assembly 13 in FIG. 8 may be replaced by a linear cylinder that may be powered by hydraulic or pneumatic means.

The locking assembly 4 shown in FIG. 9 comprises a brake shoe 430, which is held in place between the covers 2 and 3 by means of a spring 44. The locking assembly 4 also comprises means to release the brake manually by a release button 47, which pushes a release pin 45. The release button 47 is forced out by a spring 46 and is held in place by a retaining ring 48.

The caster wheel of the present invention may be locked by means of electric, hydraulic, or pneumatic power, in such a way that a user may lock both the rotation direction of the vertical axis.

The present caster wheel uses a gear assembly to increase torque and decrease speed, a screw and nut assembly to provide a means of transforming rotational power into linear power and actuate a brake, as now described in relation to FIG. 10.

Locking is accomplished by providing power to the motor 29. The gear assembly 30, 32 (see FIG. 8) provides a means to reduce speed and increase torque causing the drive screw 40 to rotate which forces the drive nut 22 down (see FIG. 7). The force of the drive nut 22 is transmitted through the housing 23 of the internal shaft assembly 14, which has a semi-circle groove to retain a number of balls 26 which transmit the force to the square shaft 28 of the internal shaft assembly 14. The square shaft 28 presses down on the brake foot 19 (see FIG. 6), which has teeth that mate with the brake shoe 430 to prevent vertical rotation. The brake shoe 430 has teeth arranged radially to engage the surface of the wheel 1 to prevent horizontal rotation.

The user may manually override the locked caster wheel, in case of power failure, and allow the wheel to rotate in both the vertical and horizontal axis. Further, the brake can be reset by applying power to unlock the wheel, which will re-engage the drive system for power function.

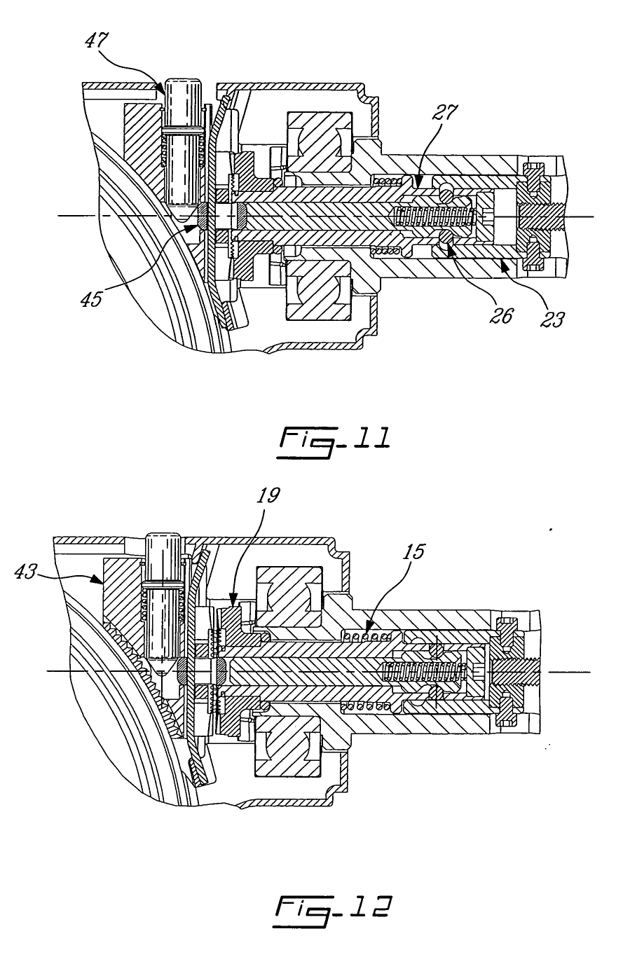

FIGS. 11 to 14 show the functionality of the manual override. FIG. 11 shows the manual release button 47 depressed which presses the release pin 45 up. The release pin 45 presses the release shaft 27 up. The undercut in the release shaft 27 allows the balls to move inward and disengage the square shaft 28 from the housing 23. Because the balls 26 are engaged slightly less than their centerline the force applied to the brake tends to disengage the balls.

As seen in FIG. 12, the spring 15 pushes the square shaft 28 up, which releases the brake foot 19. The caster wheel may then rotate in either the vertical or horizontal axis.

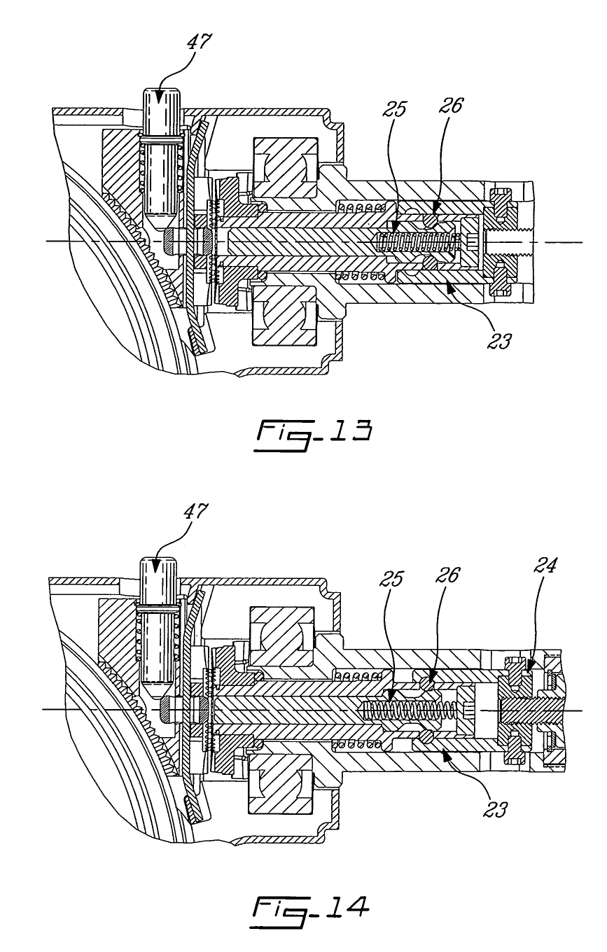

As shown in FIG. 13, the balls 26 remain disengaged even with the release button 47 released. To re-engage, the drive power is applied to the motor in the unlocking direction as shown in FIG. 14. The housing 23 moves up to allow the balls 26 to re-engage. The spring 25 applies force to the release shaft 27, which applies a load on the balls 26 to cause them to re-engage the undercut in the housing 23. The manual override is then reset.

The brake may be actuated by using a pneumatic or hydraulic cylinder.

The present invention allows locking the wheels without having to apply physical power directly to the wheel. This allows the user to lock or unlock any or all wheels by using an electrical interface, such as a switch or a keypad device for example.

Moreover, the present invention allows eliminating a linkage otherwise standardly used to be able to control all of the wheels from one location. Eliminating the linkage will result in cost and space reduction, which may be of interest in cases when space is a critical aspect, for example in relation to hospital beds. Contrary to current caster wheels used for hospital beds for example, the present caster wheels may be locked from any location where an activation pad is located versus a typical hospital bed with locking casters that may only be locked from either side of the bed.

The above caster wheel allows only a total lock functionality. It may be desired to have the ability to have rotational lock or total lock in an electrically controlled wheel.

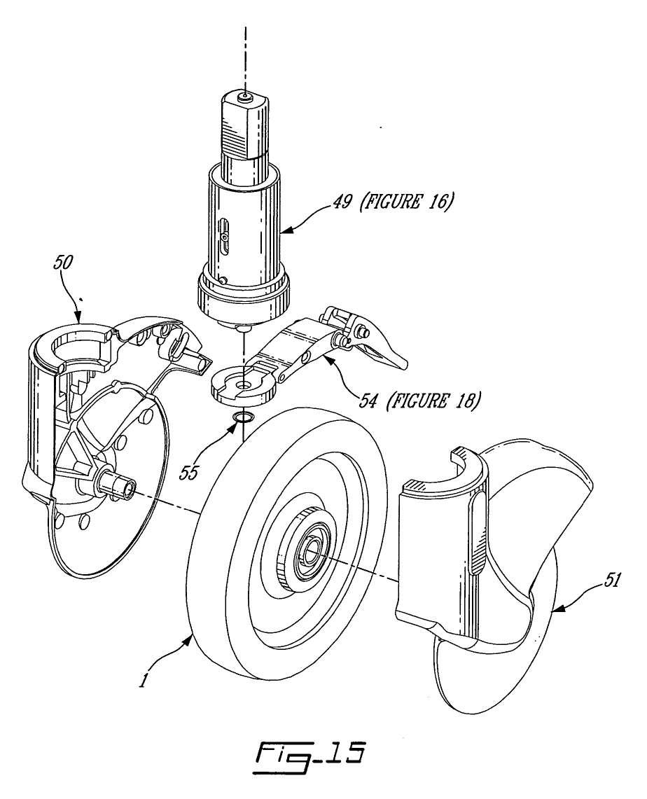

In a second embodiment, a lever system may be used as shown in FIG. 15 to allow either functionality. The lever system comprises a drive assembly 49, two covers 50 and 51, a wheel 1, a locking assembly 54.

The drive assembly 49 shown in FIG. 16 comprises a motor assembly 56, which engages an internal shaft assembly 57. The internal shaft assembly 57 moves up and down in a main shaft 60 and is guided by a bushing 59 and is prevented from rotating by two shoulder bolts 64. A splined collar 58 having teeth, which can mate with the internal shaft assembly 57, is assembled to the main shaft 60 by two dowel pins 65. An alignment collar 62 mates to the main shaft 60 and is held in place with a retainer 64. The assembly is connected to the two covers 50 and 51 through a bearing 61.

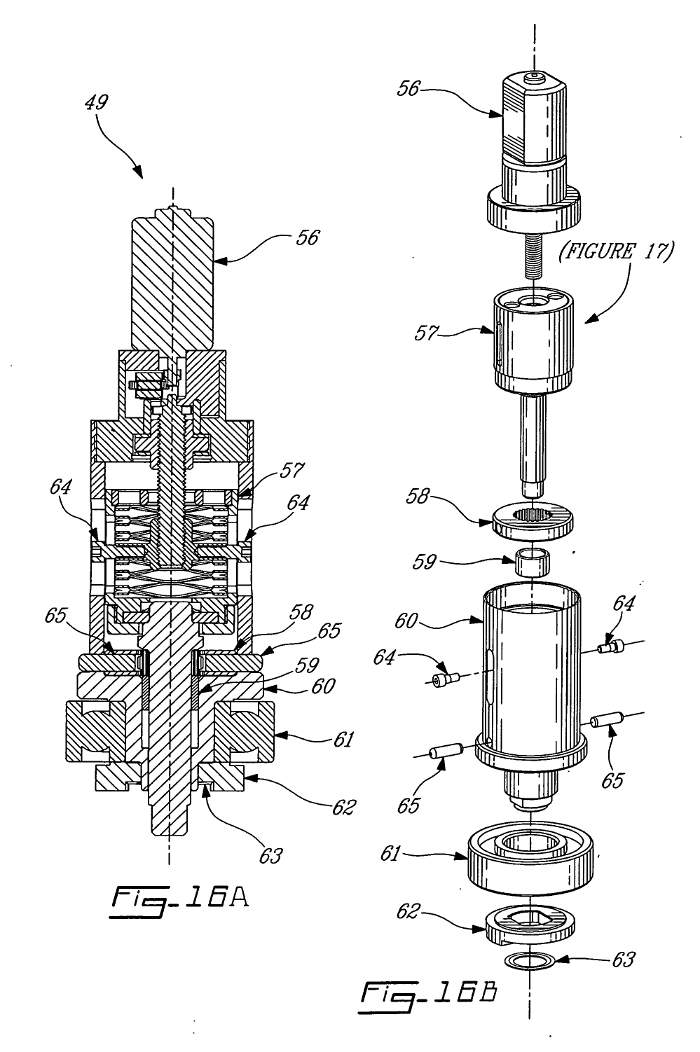

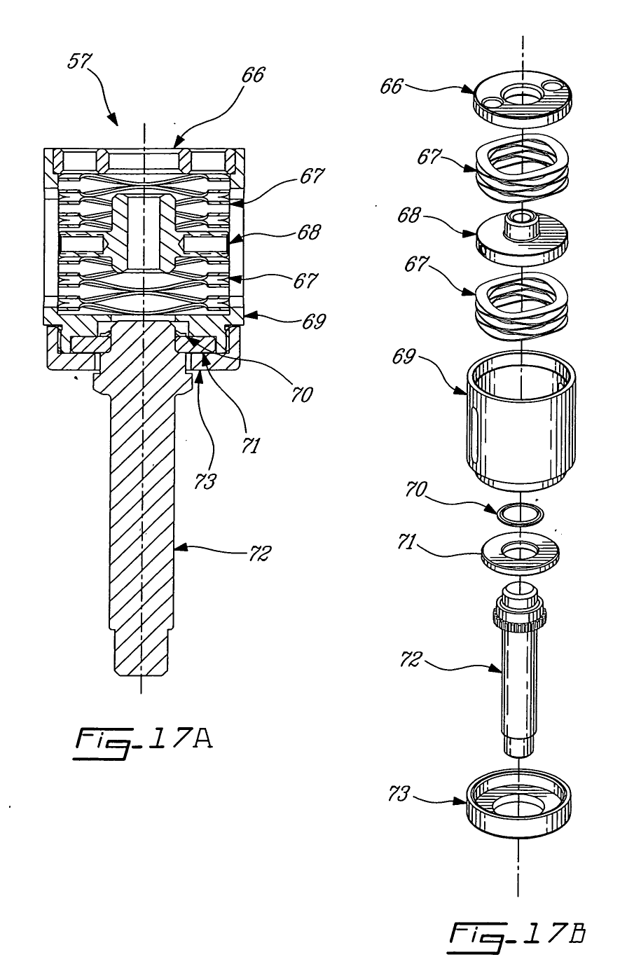

The internal shaft assembly 57 as shown in FIG. 17 comprises a housing 69, which contains a series of springs 67 that sandwich the drive nut 68 and are contained by a cap 66. A splined shaft 72 is connected to the housing 69 through a thrust bearing 71, which is held in place by a retainer 70 and contained by a bottom cap 73.

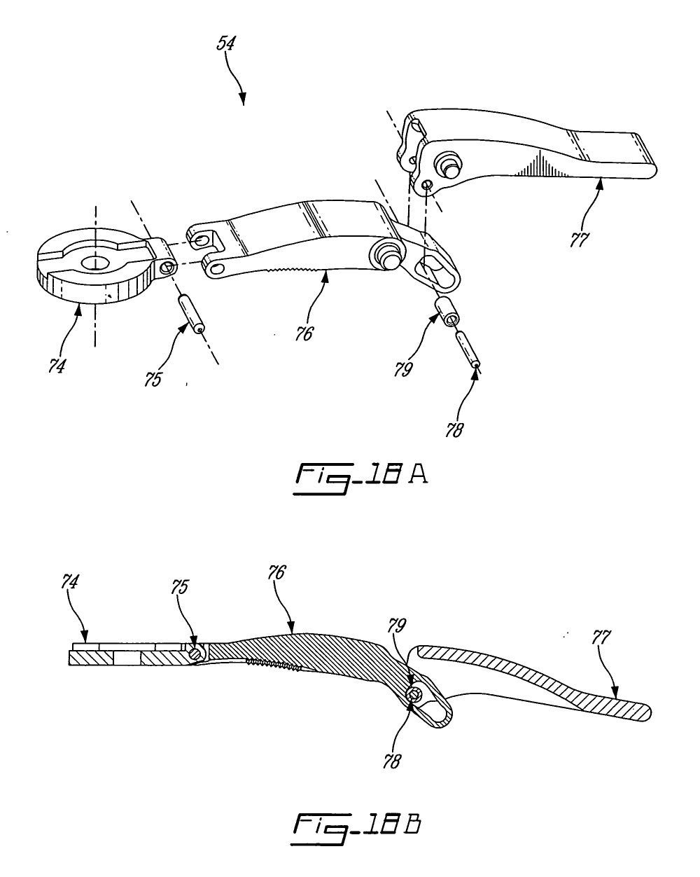

The locking assembly 54 shown in FIG. 18 comprises a brake lever 76, which is attached to an alignment plate 74 through a dowel pin 75. A manual release lever 77 is connected to the brake lever 76 by a roller 79 and a dowel pin 78.

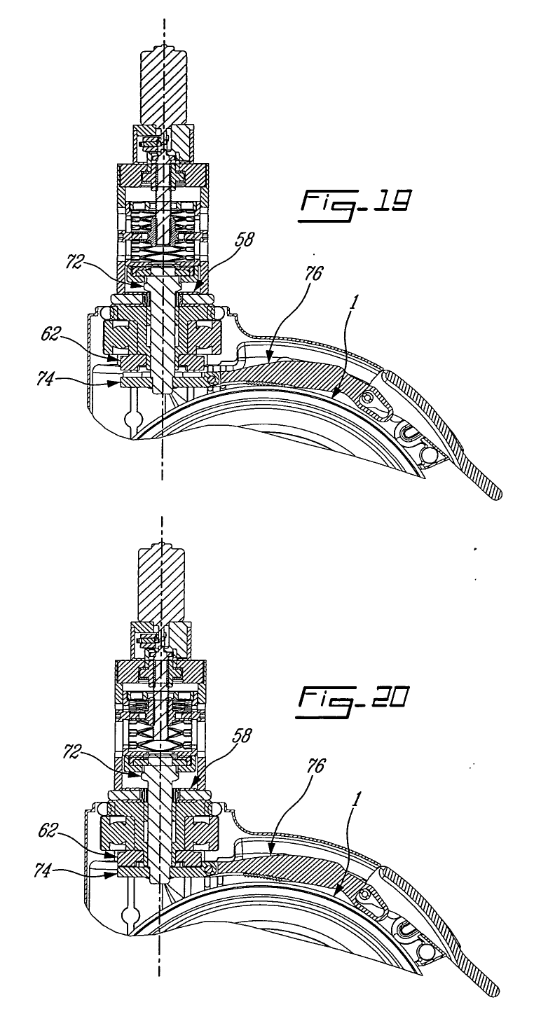

FIG. 19 shows the caster wheel of FIG. 15 in the neutral position. The caster wheel may rotate in the vertical axis because there is clearance between the splined shaft 72 and the splined collar 58 as well as between the alignment collar 62 and the alignment plate 74. There is also clearance between the brake lever 76 and the wheel 1 to allow horizontal rotation. The springs 67 in the housing 69 are balanced (see FIG. 17).

FIG. 20 shows the caster wheel of FIG. 15 in the rotational locking position. The motor assembly 56 pulls the drive nut 68 upward and applies a load the upper springs 67, applying an upward load to the housing 69 and splined shaft 72. The alignment plate 74 is pulled in the upward direction to engage the alignment collar 62. If the teeth are not properly aligned, the springs keep an upward force on the alignment plate 74 until the wheel rotates to the proper alignment and the teeth are engaged to prevent any further vertical axis rotation.

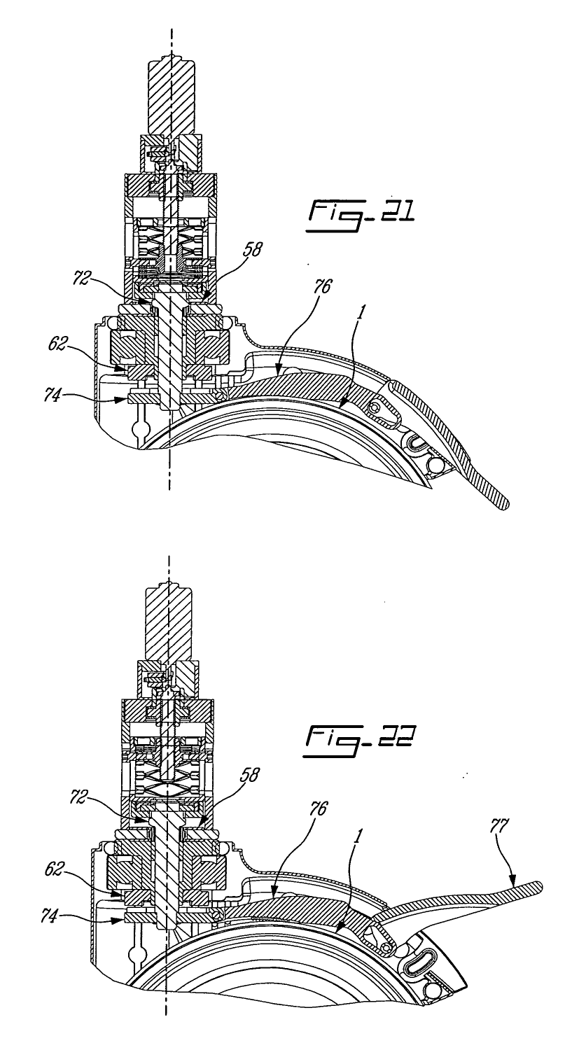

FIG. 21 shows the caster wheel of FIG. 15 in the total locking position. The motor drive 13 pushes the drive nut 69 downward and applies a load to the lower springs 67, applying a downward load to the housing 69 and splined shaft 72 (see FIG. 17). The splined shaft engages the splined collar 58 and prevents rotation around the vertical axis. The splined shaft 72 applies a downward force on the alignment plate 74, which applies a downward force on the braking lever 76. The braking lever 76 has teeth, which prevent the wheel 1 from rotating around the horizontal axis.

The present invention allows the user to manually override the locked caster wheel in case of power failure allowing the wheel to rotate in both the vertical and horizontal axis.

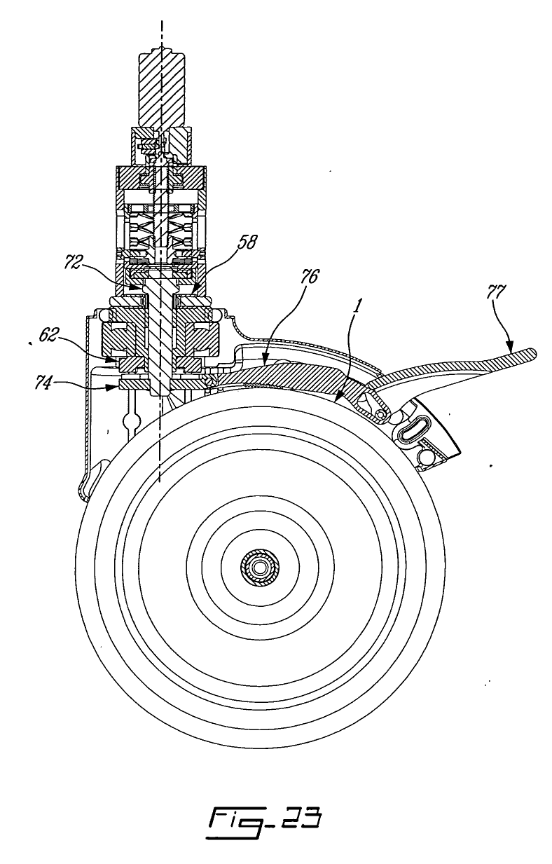

FIG. 22 shows the caster wheel of FIG. 15 in the rotational lock condition with the manual override engaged. The brake lever 76 has a shaped slot, which engages the manual release lever 77 through a roller 79. When the manual release lever 77 is raised, the brake lever 76 is forced downward, disengaging the alignment plate 74 from the alignment collar 62. The upper springs 67 in the housing 69 are further compressed. Because of the shape of the slot in the manual release lever, the force applied to the brake lever 76 causes the release lever to remain in the unlocked position. When the drive motor 13 is actuated and the springs 67 reach a balanced load condition, the manual release lever will no longer have a load and will automatically return to the normal operating condition, allowing powered function.

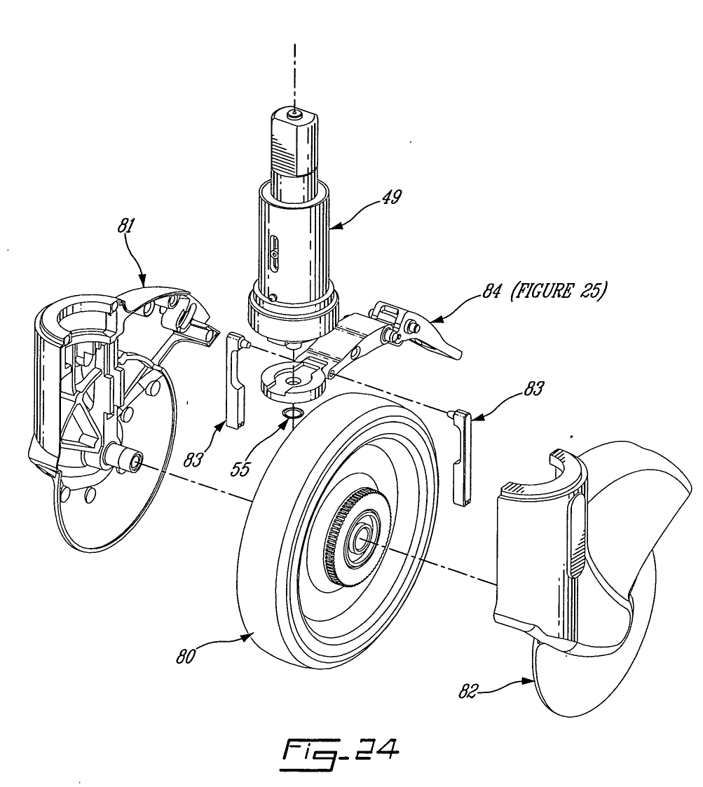

FIG. 23 shows the caster wheel of FIG. 15 in the total lock position with the manual override engaged. In this case, the manual release lever 77 will force the brake lever 76 in the upward direction, allowing wheel rotation. The splined shaft is also forced upward, further compressing the upper springs 67 contained in the housing 69, allowing rotation around the vertical axis. Again the shape of the slot tends to apply a force keeping the manual release lever 77 in the override position. When the drive motor 13 is actuated and the springs 67 reach a balanced load condition, the manual release lever will no longer have a load and will automatically return to the normal operating condition, allowing powered function.

The above described caster wheel assemblies use a brake shoe to apply pressure directly to the wheel to prevent the wheel from rotating.

In still a further embodiment, the caster wheel assembly may use teeth arranged radially on both sides of the wheel and a locking pin that engages the teeth to prevent rotation, which may be suitable with either single or double wheel casters as shown in FIG. 24. This caster wheel consists of the drive assembly 49, as described earlier, a lever assembly 84, which is held in place by a retainer 55, and two locking shoes 83. The wheel 80 has radially arranged teeth and is held in place by two covers 81 and 82.

This caster wheel assembly may be locked using the same linear drive mechanism as described earlier or may use a hydraulic or pneumatic actuator.

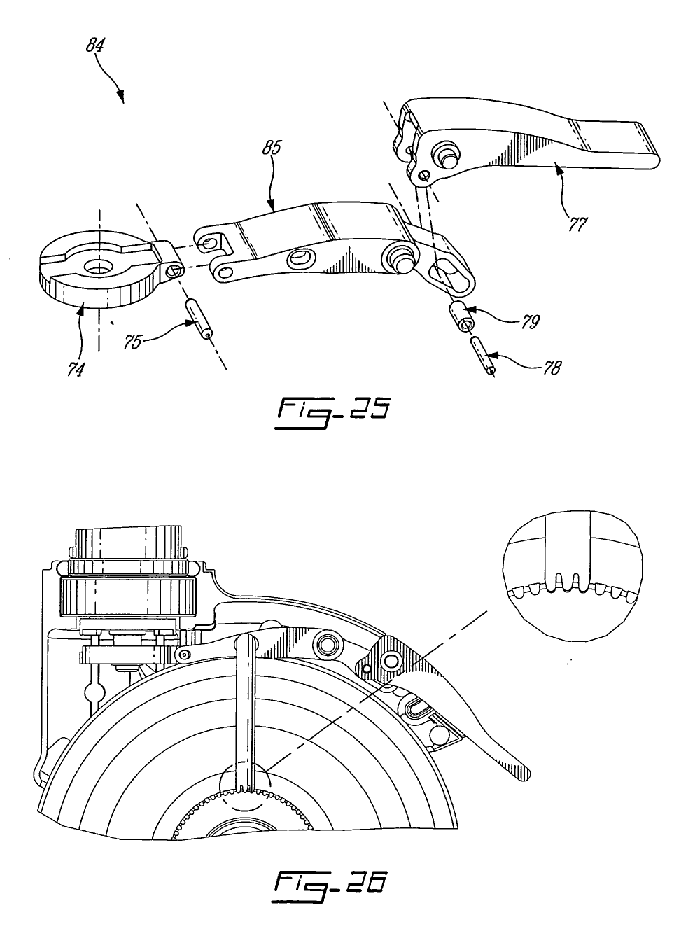

FIG. 25 shows the lever assembly 84, which is comprised of the alignment plate 74, as described earlier, a lever 85 with slots that mate to the locking shoes 83. A manual release lever 77 is provided as earlier described.

The rotational lock function is the same as previously described. FIG. 26 shows the caster wheel in the total lock condition where the teeth on the locking shoes 83 engage with the teeth on the wheel 80 to prevent horizontal rotation. Vertical rotation is prevented by the same spline mechanism described earlier.

This caster wheel also provides a mechanical override which functions as previously described.

The previously described power locking caster wheels all contain a locking mechanism in each wheel. However, it is contemplated that there may be applications where it is not feasible or desired to have each wheel contain a powered mechanism. In these cases the powered mechanism may be attached directly to the existing linkage mechanism discussed earlier.

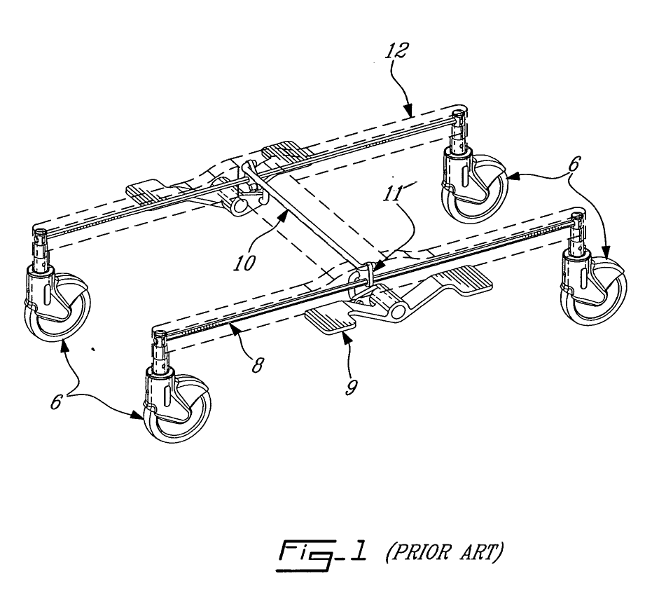

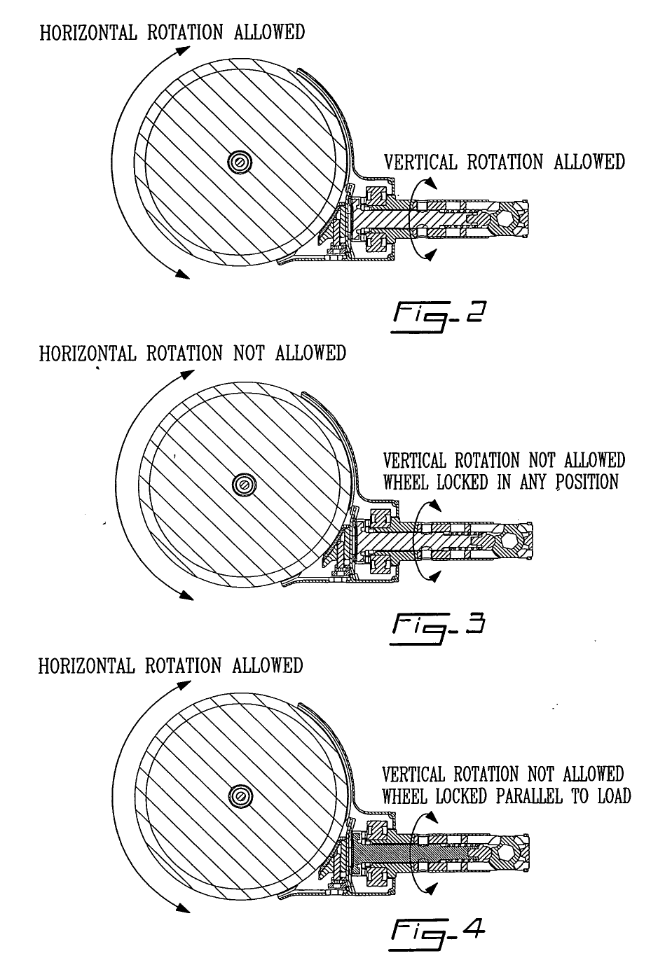

As shown in FIG. 1, a caster wheel assembly for a hospital bed uses a foot pedal 9, which is attached to a splined rod 8 through a linkage assembly 11. Splined rods 8 on both sides of the frame 12 of the hospital bed are connected by a connecting rod 10. The connecting rod 10 causes the pedals 9 and splined rods 8 on both sides of the bed to rotate at the same time in a same direction. Each splined rod 8 is connected to caster wheels 6 which are mounted in the bed frame 12. Pressing the pedal 9 in one direction causes the splined rod 8 to rotate and lock the caster wheel 6 around the vertical axis. Pressing the pedal in the opposite direction causes the splined rod to rotate in the opposite direction and locks the wheel around both the vertical and horizontal axis. The pedals may be used from either side of the frame 12.

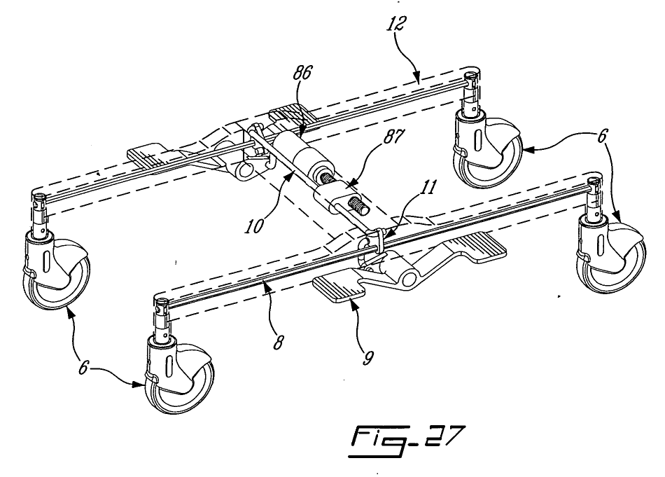

As illustrated in FIG. 27, in the case of a hospital bed, according to an embodiment of the present invention, a linear actuator 87 is added to the linkage assembly, thereby allowing the caster wheels 6 to be locked or unlocked without the limitation of being on one side of the bed or the other and eliminates the need to manually lock the caster wheels. The linear actuator 87 can be used in conjunction with the manual pedals 80 which may manually override the powered mechanism. Alternatively, the pedals may be eliminated to reduce cost and complexity. The linear actuator 90 may be electrically, hydraulically, or pneumatically actuated.

The caster wheels of the present invention may not only be used in hospital equipment and furniture, such as hospital beds, wheel chairs, diagnostic equipment, but also in a variety of products that require mobility through caster wheels, strength and locking features.

Although the present invention has been described hereinabove by way of specific embodiments thereof, it can be modified, without departing from the spirit and nature of the subject invention as defined in the appended claims.

What is claimed is:

1. A caster wheel, comprising:
a wheel contained between covers;
a drive assembly connected to said covers; and
a locking assembly connected to said drive assembly, said locking assembly applying pressure to a surface of said wheel under action of said drive assembly, thereby controlling a rotation of the wheel around both a vertical and horizontal axis.

2. The caster wheel of claim 1, wherein said drive assembly comprises a linear actuator transforming a rotational power of a motor into a linear power actuating said locking assembly.

3. The caster wheel of claim 2, wherein said linear actuator is one of: i) pneumatic cylinder and ii) a hydraulic cylinder.

4. The caster wheel of claim 1, wherein said rotational power is provided by one of: an electric motor; a pneumatic motor; and a hydraulic motor; said linear actuator being one of a threaded member of said drive assembly matting with a threaded nut of said locking assembly; a pneumatic cylinder; and a hydraulic cylinder.

5. The caster wheel of claim 1, wherein said locking assembly comprises a brake means and means to release said break means manually.

6. The caster wheel of claim 1, said drive assembly comprising:
a motor assembly with an output drive screw;
an external shaft assembly; and
an internal shaft assembly moving up and down said external shaft assembly; said internal shaft assembly comprising a threaded member matting with said output drive screw for transmission of a load from said drive assembly to said locking assembly; said internal shaft assembly comprising a housing connected to a square shaft through a number of balls maintained in place by a release shaft;
and said locking assembly comprising a brake shoe held in place between said covers and connected to said internal shaft;
wherein rotation of said output drive screw forces said threaded member down, transmitting a linear force through said housing of said internal shaft assembly, said balls transmitting the linear force to said square shaft, said square shaft pressing on a brake foot having teeth matting with said brake shoe to prevent vertical rotation of the wheel; said brake shoe having teeth arranged radially to engage the surface of the wheel to prevent horizontal rotation thereof.

7. The caster wheel of claim 6, further comprising a manual release override including a release button and a release pin, said release button pushing said release pin, said release pin pressing the release shaft up to disengage the balls, thereby disengaging said square shaft from said housing, and releasing the brake shoe from a locked position thereof.

8. The caster wheel of claim 2,
said drive assembly comprising a main shaft; a splined collar having teeth being assembled to said main shaft, an alignment collar matting with said main shaft; an internal shaft moving up and down a main shaft, a motor assembly engaging said internal shaft assembly; said internal shaft assembly comprising a housing containing a spring set driving a drive nut; a splined shaft being connected to said housing; and
said locking assembly comprising a brake lever attached to an alignment plate;
wherein
in a neutral position, there is a clearance between said splined shaft and said splined collar, between said alignment collar and said alignment plate, and between said brake lever and the wheel, the spring set in the housing being balanced;
in a rotational locking position, the motor assembly pulls said drive nut upwards and applies a load to the spring set, applying an upward load to the housing and splined shaft, pulling the alignment plate upwards in engagement with the alignment collar, the spring set maintaining an upward force on the alignment plate until engagement of the teeth, thereby preventing further rotation of the wheel around a vertical axis; and
in a total locking position, the motor assembly pulls said drive nut downwards and applies a downward load to the spring set, applying a downward load to the housing and splined shaft, said splined shaft engaging said splined collar thereby preventing rotation of the wheel around the vertical axis, and applying a downward force on said alignment plate, said alignment plate applying a downward force on the braking lever, teeth of the braking lever engaging the wheel, thereby preventing rotation of the wheel around an horizontal axis.

9. The caster wheel of claim 8, further comprising a manual brake override, said manual brake override allowing rotation of the wheel about both axes in a locking position.

10. The caster wheel of claim 9, said manual brake override comprising a manual release lever, said brake lever having a shaped slot engageable with said manual release lever,
wherein
in the rotational locking position, raising of the manual release lever forces the brake lever downwards, disengaging said alignment plate from said alignment collar, further compressing the spring set in the housing, the force applied to the brake lever and releasing the brake lever is maintained by the shaped slot, until the motor assembly is actuated and the spring set reaches a balanced load; and
in the total lock position, the manual release lever disengages the brake lever upwards from the wheel and forces the splined shaft upward, further compressing the spring set in the housing, the shaped slot applying a force keeping the manual release lever in the override position, until the motor assembly is actuated and the spring set reaches a balanced load.

11. The caster wheel of claim 8, wherein said spring set comprises at least one of: i) pneumatic springs, ii) polyurethane springs, and iii) resilient members.

12. The caster wheel of claim 2, said drive assembly comprising a main shaft; a splined collar having teeth matting being assembled to said main shaft, an alignment collar matting with said main shaft; an internal shaft moving up and down a main shaft, a motor assembly engaging said internal shaft assembly; said internal shaft assembly comprising a housing containing a spring set driving a drive nut; a splined shaft being connected to said housing;
said wheels comprising teeth arranged radially on both sides thereof; and
said locking assembly comprising a lever assembly and locking shoes, said lever assembly comprising an alignment plate and a braking lever with a slot, said breaking lever being connected to a release lever by a roller matting said slot;
wherein
said slot forces said breaking lever to a neutral position when the release lever is raised; said slot transmitting a force from the spring set onto said roller thereby maintaining the breaking lever in a release condition until a load is released from the release lever.

13. An assembly, comprising a number of caster wheels as of claim 1, each caster wheel being provided with a locking mechanism.

14. An assembly, comprising a number of caster wheels as of claim 1, the caster wheels being connected by a linkage driven by a central assembly drive.

15. The caster wheel of claim 14, wherein said central drive assembly is one of: i) an electromechanical actuator driven by an electric motor; a pneumatic cylinder; and a hydraulic cylinder.

16. The caster wheel of claim 14, comprising pedals for a manual actuation of the caster wheels.

17. The caster wheel of claim 16, said linkage comprising a linear actuator, said linear actuator locking and unlocking wheels.

18. The caster wheel of claim 17, further comprising a manual override system.

19. A hospital equipment comprising the caster wheel of claim 1.

20. A mobile equipment comprising the caster wheel of claim 1.

21. A hospital equipment comprising the assembly of claim 14.

22. A mobile equipment comprising the assembly of claim 14.
